(19) United States
(12) Patent Application Publication
(10) Pub. No.: US 2012/0263699 A1
(43) Pub. Date: Oct. 18, 2012

(54) Compositions and Methods for Preservation of Fresh Produce

(75) Inventor: Stephen Jeffrey Gorton, Rowlett, TX (US)

(73) Assignee: NZYMSYS, INC., East Hartford, CT (US)

(21) Appl. No.: 13/444,494

(22) Filed: Apr. 11, 2012

Related U.S. Application Data
(60) Provisional application No. 61/475,056, filed on Apr. 13, 2011.

(51) Int. Cl. A01N 63/02; A01P 3/00; A01N 65/36; A01P 1/00

(52) U.S. Cl. 424/94.2; 424/94.61; 424/94.6; 424/94.63

(57) ABSTRACT

The present invention is concerned with compositions and methods for treatment of fresh produce to reduce the levels of bacterial and/or fungal contamination. The compositions comprise the ingredients selected from a source of chlorite ions, enzymes, grapefruit seed extract, and an agent for adjusting the pH of the composition, and a pH buffering system to maintain a stable pH. The methods of preserving produce include applying the compositions to produce, to the trees or plants that bear produce, or to the packing materials used to pack, ship and sell the produce.

### CROSS-REFERENCE TO RELATED APPLICATIONS

This application claims the benefit of U.S. Provisional Application Ser. No. 61/475,056 filed Apr. 13, 2012, which is incorporated herein in its entirety.

### FIELD OF THE INVENTION

The present disclosure relates to compositions for producing fresh fruits and vegetables with reduced level of bacterial and/or fungal contamination. The disclosure also relates to methods of applying the compositions to fresh fruits and vegetables before and/or after harvest.

### BACKGROUND OF THE INVENTION

The present disclosure relates to compositions for producing fresh harvested fruits and vegetables with reduced level of bacterial and/or fungal contamination. The disclosure also relates to methods of applying the compositions to fruits and vegetables before and/or after harvest.

Preserving fresh fruits and vegetables (hereafter “produce”) in a savory, fresh condition for an extended period of time is a critically important task in the agricultural industry. After harvest, produce has a limited shelf life before deterioration deleteriously affects their palatability, nutritional value, odor, and taste due in large part to the attack of microorganisms. Deterioration can lead to food spoilage and may present health risks to people who unsuspectingly consume the spoiled produce. Numerous factors have been identified which can initiate produce spoilage. These factors include changes in environmental conditions (such as temperature, moisture and air quality), action of insects, natural food enzyme activity, and the activity of microorganisms. Many of the microorganisms, at elevated levels, are pathogenic to humans when ingested. Pathogens that are implicated in produce deterioration include bacteria, such as E. coli, Listeria monocytogenes, and Salmonella choleraesuis, and fungi, such as Alternaria alternate, Alternaria solani, Botrytis Cinerea, Fusarium oxysporum, Phytopthora infrestans, Phytopthora capsici, Phytopthora sojae, Colletrichum gleosporiodes, Colletrichum capsici, and Colletrichum cassilicola. These pathogens also include any similar microbial agent or residue from an agent that can cause disease in human, shorten shelf life of produce, or decrease produce output of plants or trees.

Problems arising from the limited shelf-life of fresh produce are further complicated by the fact that some fruit and vegetables are often seasonal or grown only in certain regions of the globe and therefore must travel considerable distances to reach intended consumers. The elapsed time period experienced in the transportation of the produce can exhaust a high portion of the produce shelf-life, leaving the seller with a much shorter time period in which to sell the produce. Transportation modes and storage systems may subject the produce to unfavorable weather conditions, which can accelerate deterioration and thereby further reduce shelf-life. Losses resulting from deterioration of the produce can impose heavy financial burdens on produce growers and harvesters, who rely on high overall crop yields, groceries and other commercial marketplaces that seek to maximize commercial profitability, and consumers who depend on stable prices and continuous availability.

Refrigeration and controlled climate conditions are often employed during transportation, storage, and display of produce in an attempt to reduce spoilage and prolong shelf-life. While controlled environments limit the growth of food-born organisms, such environments do not decontaminate produce previously contacted with a biological contaminant, such as spoilage organisms and pathogenic bacteria. At the time of sale, the produce will retain the biological contamination, which, if left untreated, can be transported to and spread within the consumer's home. Alternatively, produce may be coated with a protective material, such as a wax, but such protective material may undesirably affect the taste of the produce.

Traditional remedies that have been used to prolong the shelf life of produce include chemical bleach washes, alkaline based washes, and treatment with anti-microbial chemicals such as sodium ortho phenyl phenate (SOPP), imazalil, or thiabendazole (TBZ). However, each of these chemicals is corrosive and may pose underlying human health hazards. TBZ and imazalil are becoming more restricted in use in most states. For example, heightened levels of imazalil and TBZ are believed to contribute to cancer and other long-term health problems. Some of these remedies have been discredited as largely ineffective and unnecessarily costly and time consuming. Further, educated consumers often are knowledgeable of the adverse consequences associated with these chemicals and will decline to purchase produce treated with these chemicals.

It would be a considerable advantage to produce growers, distributors, sellers, and consumers if the deteriorating effect of microorganisms discussed above could be eliminated or substantially reduced so as to extend produce shelf life without the use of such hazardous agents. Therefore, there exists an immediate and long-felt need for a safe and effective produce treatment to reduce the activity of bacteria and fungi on fresh produce that would extend its shelf life.

### SUMMARY OF THE INVENTION

Disclosed herein is a multi-component composition which can be applied to harvested produce, to packing materials for harvested produce, or to produce-bearing trees or plants. In one embodiment, the composition comprises a source of chlorite ions and enzymes. In another embodiment, the composition comprises a source of chlorite ions, enzymes, and grapefruit seed extract. In some instances, the composition may be treated with acid to adjust the pH to about 3.5 and buffered to maintain a constant pH in solution. Yet in another embodiment, a method is disclosed for applying one or more of the aforementioned compositions to harvested produce, to packing materials for harvested produce, or to produce-bearing trees or plants.

### DETAILED DESCRIPTION OF THE INVENTION

Embodiments of the invention describe herein are compositions that can be used to treat produce, plants that grow produce, or packing materials for produce. The embodiments also include methods of treating harvested produce, packing materials for harvested produce, produce bearing trees or plants with one or more of the aforementioned compositions. After the treatment, the shelf life of produce will be extended, the loss of taste reduced, the nutrition preserved, and/or the output production of plants increased. Among other things, the composition described herein reduces the level of pathogens known to cause produce spoilage, which shortens shelf life, and plant diseases, which reduce output production.

Reference will now be made in detail to the preferred embodiments and methods of the invention. It is important to note that the invention in its broader aspects is not limited to the specific details, representative compositions and methods, and illustrative examples described in connection with the preferred embodiments and preferred methods. The invention according to its various aspects is particularly pointed out and distinctly claimed in the attached claims read in view of this specification. Appropriate modifications and equivalents will be apparent to practitioners skilled in this art and are encompassed within the spirit and scope of the appended claims.

According to the first embodiment of the invention, the composition is an aqueous based mixture which reduces the level of bacteria and fungi, and/or inhibits the recurrence of the bacteria and fungi on a surface, e.g., of fresh produce, plants, or related packing materials. The composition can be applied directly and/or further diluted with water or other suitable solvents prior to use.

The composition contains a source of chlorite ions and one or more other ingredient(s) selected from enzymes and grapefruit seed extract. One embodiment of the composition comprises a source of chlorite ions, enzymes, and an agent that can adjust the pH of the composition to about 3.5. Another embodiment of the composition comprises a source of chlorite ions, enzymes, and grapefruit seed extract. Another embodiment of the composition comprises a source of chlorite ions, enzymes, grapefruit seed extract, and an agent that can adjust the pH of the composition to about 3.5. Another embodiment of the composition comprises a source of chlorite ions and grapefruit seed extract. Yet another embodiment of the composition comprises a source of chlorite ions, grapefruit seed extract, and an agent that can adjust the pH of the composition to about 3.5. The quantities of the ingredients are the amounts effective to substantially reduce the level of pathogens present on the surface of produce, plants, or packing materials.

Water is the principal ingredient of the produce-treatment composition. Distilled, aseptic water free of minerals, ions, and ion exchange components is preferred for preventing possible denaturing of active ingredients.

The source of chlorite ions can be any agent or agents that provide or generate chlorite ions in aqueous solution. Examples of the agent can be, but are not limited to, one or more of agents selected from: benzyltrimethylammonium chlorite (e.g. Sigma-Aldrich, catalog number 589020), sodium chlorite (e.g. Sigma-Aldrich, catalog number 244155, technical grade 80%), polymer-bound chlorite (e.g. Sigma-Aldrich, catalog number 568767), other chlorite salts and chlorous acid. The source of chlorite ions constitutes about 0.01 percent by weight to about 40 percent by weight of the composition, preferably about 0.05 percent by weight to about 10 percent by weight, more preferably about 0.05 percent by weight to about 2 percent by weight.

The produce treatment composition embodied herein may contain one or more additional components such as additional enzymes or enzyme blends. Without wishing to be bound by the theory, it is believed that the enzymes present in the produce-treatment composition break down the lipo-polisaccharide/amino acid/lipid cell wall and/or membrane of an offending bacteria, fungus, mycelium, spore, enterobacteria, or other microorganism (e.g., Aspergillus spp, Penicillium spp, Cladosporium, E. Coli, Pseudomonas spp, Staphylococcus aureus, Salmonella spp, etc.) and neutralize the same via a lysing mechanism. Preferably, the enzyme comprises one or more members selected from amylase, lipase, cellulase, and protease. Lipase and amylase are preferably selected for penetrating the polysaccharide outer walls and lipid membranes of fungi and bacteria. When protease is selected, it is preferably used in combination with lipase. Other enzymes, such as carbopeptidase, may be employed for use alone or in combination with the above enzymes, e.g., to enhance the enzymatic efficacy of the composition. In an especially preferred embodiment, the enzyme composition comprises amylase, lipase, cellulose, and protease.

The selected concentration of enzymes in the solution may be influenced by various factors, including the activity of the enzymes and the intended environment in which the produce-treatment composition will be used. Generally, the enzymes should be present in a composition in a concentration of at least 0.01 weight percent of the total composition weight. Preferably, the enzyme concentration in the composition is selected in a range of about 0.1 percent by weight of the total composition weight to about 15 percent by weight, more preferably about 0.1 percent by weight to 1.0 percent by weight. The composition may have, for example, a proteolytic activity between about 2,000 and 4,000 hut/gram, a lipolic activity between about 300 and 600 fip/gram, an amylotic activity between about 1,000 and 2,000 skb/gram, and a cellulolytic activity between about 450 and about 900 cu/gram, although it is within the scope of the invention to employ lower or higher activities (hut=hemoglobin unit tyrosin base, fip=International Pharmaceutical Federation units, skb=Sandstedt, Kneen, Blish units, cu=cellulase units). Typically, commercial suppliers will report the activity of their enzymes. Alternatively, the enzyme activity may be determined using established methods. High activities of enzyme concentrates available from commercial sources may be diluted for use in the composition.

Enzymes used in the present composition are preferably biologically derived fungal origin enzymes. Purified or non-purified forms of these enzymes may be used. In accordance with common practice, wild-type enzymes derived from pure cultures may be modified via protein genetic engineering techniques in order to optimize their performance efficiency for the compositions and methods of the invention. For example, the variants may be designed such that the compatibility of the enzyme(s) with other ingredients of the composition is increased. Alternatively, the variant may be designed such that the optimal pH, stability, catalytic activity and the like, of the enzyme variant is tailored to suit the particular, desired use.

Proteases are effective in hydrolyzing or breaking down proteins. Proteases useful for the purposes of the present invention may be derived for a variety of sources, including microorganisms such as those of genus Aspergillus and Bacillus. Particularly useful proteases include those of fungal origin such as from Aspergillus oryzae and Aspergillus niger and bacterial origin such as from Bacillus subtilis and Bacillus licheniformis. Amylases are carbohydrate-hydrolyzing enzymes effective in breaking down starches into sugars. Useful amylases may be obtained from a variety of sources, including, for example, Aspergillus and Bacillus microorganisms such as Aspergillus oryzae and Bacillus subtilis, respectively. Lipase is a glyceride-hydrolyzing enzyme capable of breaking down a broad range of fat, grease, oil, and other hydrophobic material. Lipases may be prepared, for example, from certain fungi, such as Rhisopus oryzae. The lipase also serves to remove non-organic contaminants from the produce surface. Cellulases include one or more subcategories of enzymes that hydrolyze subcategories of cellulose, such as endocellulases, exocellulases, beta-1,3-glucanases, and beta-glucosidases. Preferred cellulases may be prepared, for example, from fungi, such as Trichoderma longibrachiatum and Aspergillus niger. Commercial sources of biologically derived enzymes are well known in the art, and include, for example, Bio-Cat, Inc. of Troy, Va., Deerland Chemical, Deerland Enzymes, Inc. of Kennesaw, Ga., and MedipharmUSA of Des Moines, Iowa. Plant-based enzymes may be obtained from well-known sources, such as Coats Aloe, International, Inc. of Dallas, Tex.

Without wishing to be bound by the theory, it is believed that the enzymes of the present invention may destroy a pathogen by either lysing its cell membrane or by damaging the pathogen cell's transmembrane protein receptors. When the enzyme lyses the membrane, the pathogen cell will rupture and die. Alternatively, the action of the enzyme may lead to denaturing (unfolding) of the transmembrane proteins. Such an action will functionally damage the proteins, break down the internal cell communication pathways and result in the ultimate death of a pathogen organism. The product is believed to work by disabling the receptor site (protein receptor site) stopping or interfering with the cell's ability to exchange nutrients and gases (oxygen and carbon dioxide).

The composition may also contain an agent capable of adjusting the pH of the final solution to a value in the range from about 3.1 to about 4.5, preferably about 3.5. Citric acid is an example of such an agent. Other agents known to persons ordinary skilled in the art, for example, vinegar, lemon juice, other acids or acid anhydrides, may also be used to adjust the pH of a composition to any value within the above range, and are within the scope of the invention. Those agents may include, but are not limited to, hydrochloric acid, hydrobromic acid, hydroiodic acid, hypochloric acid, chloric acid, perchloric acid, sulfuric acid, phosphoric acid, methanesulfonic acid and/or its anhydride, ethanesulfonic acid and/or its anhydride, benzenesulfonic acid and/or its anhydride, p-toluenesulfonic acid, and/or its anhydride, acetic acid and/or its anhydride, formic acid and/or its anhydride, gluconic acid and/or its anhydride, lactic acid and/or its anhydride, oxalic acid and/or its anhydride, tartaric acid, and/or its anhydride, ascorbic acid and/or its anhydride, Meldrum's acid and/or its anhydride.

The pH of the composition has an effect on its antifungal and antibacterial activity. A composition with pH of about 8.5 to about 9 can effectively kill a wide range of pathogenic bacteria and fungi. At that pH, the composition can be stored at ambient temperature for about two years. A composition with pH of about 3.5 is also capable of killing a wide range of pathogenic bacteria and fungi, although it is less stable in storage. Without wishing to be bound by theory, it is possible that under acidic conditions, sodium chlorite forms a semi-stable intermediate, chlorous acid. Chlorous acid is a strong oxidizing agent that disintegrates to form molecular oxygen and chloride ion. The action of chlorous acid is amplified by the effects of the aseptic enzymes and/or grapefruit seed extract, thus allowing the composition to work more effectively and more quickly by attaching to and breaking down the outer cell membrane of the selected pathogens. It is important to prepare the acidic composition just prior to the use.

The composition may include grapefruit seed extract (GSE) at a concentration of about 0.01 weight percent to about 10 weight percent of the composition, specifically about 0.05 weight percent to about 5 weight percent, more specifically about 0.05 weight percent to about 2 weight percent. The inclusion of GSE in the composition enhances its antifungal and antibacterial properties. While the biological effect of GSE has not been firmly established, conflicting scientific demonstrations of its antimicrobial activity have appeared in the literature. Without wishing to be bound by the theory, it is believed that the antibacterial and antifungal activity of the present composition may partially attributed to the presence of quaternary ammonium salts (such as benzalkonium chloride and benzathonium chloride), and preservative agents (such as methyl paraben and triclosan) in the product. While GSE is available from several commercial sources, the GSE product used in an illustrative embodiment of the composition—Citricidal®—was purchased from Regenesis, Inc. When grapefruit seed extract is used, the composition is effective at reducing the levels of bacteria and fungi at a pH from about 1 to about 12.

Another embodiment of the invention involves a method for treating produce with the aforementioned compositions against bacterial and fungal growth, spore germination, mycelium growth, and resistant strains of penicillium and MRSA (methacillin resistant staphylococcus aureaus). The treatment method extends to the removal, prevention, reduction, and/or resistance to recurrence of microbial growth on fresh produce, preferably post-harvest. Examples of produce that may be treated using the method and composition of the invention include fruit (e.g., citrus fruit, melons, apples, grapes, tomatoes, avocados, peaches, etc.), vegetables (e.g., potatoes, carrots, lettuce, etc.), mushrooms, stored grain (soybean, corn, etc.), nuts (e.g., tree nuts, ground nuts, peanuts, etc.), and the like. The treatment method also extends to preventative and active treatment of the trees and plants that bear the produce, and the packing materials used for packing, shipping and selling of the produce.

Generally, the method involves contacting produce, the trees and plants, or the packing materials with an effective amount of the composition for sufficient contact time to substantially reduce the levels of bacteria or fungi. The contact time will depend upon several interdependent variables, including the amount and type of fungus and other contamination on the surface to be cleaned, the effectiveness of the particular application technique employed, transportation time for the produce to reach its destination for sale, among other factors, and can be determined by a person skilled in the art. The composition may be applied to the surface by any known or suitable application technique such as spray, atomization, coating, immersion, ultrasonic, dip, drench, etc. For unpicked produce, the trees and plants, and the packing materials, a preferred application is spraying. Field spraying of the trees and plants can be performed during the growing season. Field spraying of produce can be performed several weeks before the produce are mature and/or several days before harvesting. For picked produce, the preferred methods are spraying and drenching. The contact time will depend upon several variables, including the amount and type of fungi and other contaminations on the surface to be cleaned, the effectiveness of the particular application technique employed, transportation time for the produce to reach its destination for sale, and other factors. Because the produce-treatment composition is safe for humans, removal of the composition is optional. The composition removal, if desired, can be accomplished by using known techniques, such as rinsing the produce with water. Treatment with the same or different produce-treatment compositions may be applied consecutively or simultaneously if desired.

### EXAMPLES

Examples of produce treatment compositions and methods of making the same will now be described in detail. It is important to note that these examples are only for illustration and are not intended to limit the scope of the present invention, which is defined only by the appended claims.

1. Preparation of Ingredients.

The ingredients for the produce wash compositions—solutions A, B and C—were prepared as described below.

### Solution A

Dry sodium chlorite (80% technical grade, GSF Chemicals) was dissolved in deionized water to provide a solution of 80 weight percent sodium chlorite in water.

### Solution B

A dry enzyme blend on glucose carrier having the composition set forth in Table 1 (individual food-grade enzymes were purchased from Bio-Cat, Inc.) was hydrolyzed in deionized water to provide a solution of 10 weight percent enzyme blend in water.

### Solution C

Grapefruit seed extract (product code Citricidal®, Regenesis, Inc.) was dissolved in deionized water to provide a solution of 80% weight percent grapefruit seed extract in water.

2. Preparation of Produce Wash Compositions.

Produce wash compositions 1-4 were prepared as described below:

### Composition 1

Deionized water (100 L), 0.0011 percent by weight of solution A and 0.4 percent by weight of solution B were vigorously stirred in a blender for 15 min. Citric acid was added to the resulting mixture to adjust the pH to about 3.5.

### Composition 2

Deionized water (100 L), 0.0011 percent by weight of solution A, 0.4 percent by weight of solution B and 0.2 percent by weight of solution C were vigorously stirred in a blender for 15 min. Citric acid was added to the resulting mixture to adjust the pH to about 3.5.

### Composition 3

Deionized water (100 L), 0.0011 percent by weight of solution A, 0.4 percent by weight of solution B and 0.2 percent by weight of solution C were vigorously stirred in a blender for 15 min. The pH of the resulting mixture was determined to be about 9.5.

### Composition 4

Deionized water (100 L), 0.0011 percent by weight of solution A, 0.4 percent by weight of solution B and 0.2 percent by weight of solution C were vigorously stirred in a blender for 15 min. Citric acid was added to the resulting mixture to adjust the pH to about 8.7.

### Composition 5

Solid sodium chlorite (80% technical grade, GSF Chemicals) (35 percent by weight) and grapefruit seed extract (product code Citricidal®, Regenesis, Inc.) (65 percent by weight) were mixed and milled in a blender to a fine powder. The resulting mixture may be conveniently stored. For the use it is dissolved in deionized water (100 to 500 fold excess by weight).

### Composition 6

Solid sodium chlorite (80% technical grade, GSF Chemicals) (15 percent by weight), grapefruit seed extract (product code Citricidal®, Regenesis, Inc.) (28 percent by weight) and enzymes (individual food-grade enzymes were purchased from Bio-Cat, Inc.) (57 percent by weight) were mixed and milled in a blender to a fine powder. The resulting mixture may be conveniently stored. For the use it is dissolved in deionized water (100 to 500 fold excess by weight).

3. Determination of Effectiveness of Produce Wash Compositions.

A. General Experimental Procedure

The effectiveness of the compositions in the disclosure was evaluated by a challenge test which observed the kill rate and signs of re-growth or re-colonization of the selected bacteria and fungi species on produce. In the study, the selected bacteria and fungi species, which are known tomato pathogens, including E. coli 0157 h7, Listeria Monocytogenes, Salmonella Choleraesuis, Alternaria Alternate, Alternaria Solani, Botrytis Cinerea, Botrytis Cinerea, Fusarium Oxysporum, Phytopthora Infestans, Phytopthora Capsici, Phytopthora Sojae, Colletrichum Gleosporiodes, Colletrichum Capsici, and Colletrichum Cassilicola were used. The kill rate data indicated that each of compositions 1-4, controlled the bacteria growth at 15 seconds and at 30 seconds and controlled fungal growth at 30 minutes after application. There were no signs of re-growth or re-colonization of the selected bacterial species or the fungal species tested in the challenge test. The tested composition caused more than a 2-log reduction in the level of fungi and bacteria. The details of the test are indicated below.

Cultures of the microorganisms Pseudomonas aeruginosa (ATCC No. 9027, Quality Technologies, Inc.), Escherichia coli (ATCC No. 8739, Quality Technologies, Inc.), Enterobacter cloacae (ATCC No. 13047, Quality Technologies, Inc.), Staphylococcus aureus (ATCC No. 6538, Quality Technologies, Inc.), Aspergillus niger (ATCC No. 16404, Quality Technologies, Inc.), Aspergillus flavus (ATCC No. 26946, Quality Technologies, Inc.), Aspergillus parasiticus (ATCC No. 26863, Quality Technologies, Inc.), Penicillium species (in-house), Penicillium citrinum (ATCC No. 32006, Quality Technologies, Inc.), Klebsiella pneumoniae (ATCC No. 13882, Quality Technologies, Inc.), Salmonella typhimurium (ATCC No. 14028, Quality Technologies, Inc.), Streptococcus anginosus (ATCC No. 33397, Quality Technologies, Inc.), Rhizopus stolonifer (ATCC No. 14037, Quality Technologies, Inc.), and Penicillium digitatum were maintained as stock cultures from which working inocula were prepared. The viable microorganisms used were not more than five passages removed from the original stock culture, wherein one passage is defined as the transfer of organisms from an established culture to fresh medium. Plate preparation, inoculum and kill rate data collection were performed in accordance with ASTM E2315.03. All plate dilutions were performed in duplicate. See Murry, Patrick R., Ellen Jo Baron, James H. Jorgensen, Michael A. Pfaller and Robert H. Yolken, Assessment of Bactericidal Activity by the Time-Kill Method, Manual of Clinical Microbiology, 8^{th} Edition, ASM Press, Washington, D.C. (2003), pp. 1187-1188.

B. Preparation of Inoculum:

1. Inoculate the surface of a suitable volume of solid agar medium from a recently grown stock culture of each of the microorganisms. Incubate the bacterial cultures at 35° C.±2° C. for 24-48 hours. Incubate the fungal cultures at 35° C.±2° C. for 2-7 days.

2. Determine the number of viable microorganisms in each milliliter of the inoculum suspensions by serial dilution in sterile 0.85% phosphate buffered saline, pH 7.2±0.2.

3. Plate dilutions of 10⁻³ to 10⁻⁸ in duplicate for test organisms.

4. Overlay with approximately 20 mL of 45° C. tryptic soy agar with lecithin and Tween 80, sabouraud dextrose agar or potato dextrose agar.

5. Incubate for 48-96 hours at 35° C.±2° C. for the aerobic organisms.

6. Count test organisms.

7. Calculate the number of organisms as colony forming units per mL (cfu/mL) of inoculum as follows:

$$\frac{cfu \text{/} ml ( 0.1 ml )}{9.9 ml} = cfu \text{/} ml of product$$

C. Preparation of Test Samples:

1. Accurately pipette 0.9 mL of product into an appropriately labeled or coded test tube.

2. Store test samples at ambient room temperature.

D. Inoculation of Plating of Samples:

1. Aseptically transfer 0.1 mL of the test organism into an appropriately labeled 9.9 mL of test material. The test organism was inoculated as a pure culture into a single 9.9 mL of test material.

2. Thoroughly mix or stir all samples.

3. Allow the samples to stand for one hour, twenty-four (24) hours, and forty-eight (48) hours.

4. Remove one milliliter aliquots at the indicated times and transfer to 9.0 mL sterile saline.

5. Perform serial dilutions from 10⁻¹ to 10⁻⁵.

6. Transfer 1.0 mL of each dilution into a 100×15 mm Petri plate.

7. Overlay with approximately 20 mL of 45° C. tryptic soy agar with lecithin and Tween 80, sabouraud dextrose agar or potato dextrose agar.

8. Gently swirl plates and allow to solidify.

9. Incubate plates for 48-96 hours at 35° C.±2° C.

E. Sample Evaluation.

1. Read the plates and record the results on an appropriate data sheet.

2. Using the calculated inoculum concentration for each test microorganism, calculate the log reduction for each microorganism to determine kill rate. The plates were done in duplicate and the kill rate number was the average of the two separate plates for each organism for each specified time period.

F. Records and Reports.

### Examples 1-2

Table 2 demonstrates the effectiveness of Composition 1 (pH=3.54) and Composition 2 (pH=3.57) against Bacillus subtilus, one of the most difficult spore-forming organisms to kill, control, and/or regulate. Bacillus subtilus is an accepted FDA target organism for testing of sterilant and disinfectant products.

### Example 3

Table 3 demonstrates the effectiveness of Composition 2 (pH=3.54) and Compositions 3 (pH=9.50) against bacteria Methicillin-resistant staphylococcus (MRSA).

### Examples 4-6

Table 4 demonstrates the effectiveness of Solution B against fungi spore Aspergillus niger.

### Examples 7 and 8

Table 5 demonstrates the effectiveness of Composition 2 (pH=3.54) and Compositions 3 (pH=9.50) against fungi spore Aspergillus niger.

### Examples 9-13

Table 6 demonstrates the effectiveness of Composition 4 (pH=8.75) against selected tomato pathogens.

### Examples 11-37

Table 7 (examples 11-37) demonstrates the effectiveness of Composition 4 (pH=8.75) against selected fungi.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

TABLE 1
Composition of Enzyme Blend.

| | Type | | | |
|---|---|---|---|---|
| Enzyme | Derived | Source | Units (gram⁻¹) | |
| Protease | Fungal | Aspergillus niger | 40,000 | fip/gram |
| Protease | Fungal | Aspergillus oryzae | 40,000 | fip/gram |
| Protease | Bacteria | Bacillus subtilus | 10,000 | fip/gram |
| Amylase | Fungal | Aspergillus niger | 20,000 | skb/gram |
| Amylase | Fungal | Aspergillus oryzae | 20,000 | skb/gram |
| Cellulase | Fungal | Aspergillus niger | 9,000 | cu/gram |
| Cellulase | Fungal | Aspergillus oryzae | 9,000 | cu/gram |
| Lipase | Fungal | Rhizopus oryzae | 3,000 | fip/gram |
| Lipase | Fungal | Trichoderma longibrachiatum | 3,000 | fip/gram |
| Lipase | Yeast | Candida rugosa | 3,000 | fip/gram |

TABLE 2
Effectiveness of Composition 1 (pH = 3.54) and Composition
2 (pH = 3.57) against bacteria Bacillus subtilus.

| Exam- | | Time | Log Reduction | Log Reduction |
|---|---|---|---|---|
| ple | Bacteria | (h) | (Composition 1) | (Composition 2) |
| 1 | Bacillus subtilus | 0.33 | 3.82 | 4.68 |
| 2 | Bacillus subtilus | 24 | 6.38 | 5.89 |

TABLE 3
Effectiveness of Composition 2 (pH = 3.54) and Composition
3 (pH = 9.50) against bacteria Methicillin-resistant
staphylococcus (MRSA).

| Exam- | | Time | Log Reduction | Log Reduction |
|---|---|---|---|---|
| ple | Bacteria | (sec) | (Composition 2) | (Composition 3) |
| 3 | MRSA | 15 | 6.40 | 6.40 |

TABLE 4
Effectiveness of Solution B against fungi spore Aspergillus niger.

| | | | | Plate | |
|---|---|---|---|---|---|
| Exam- | | Time | Innoculum | Count | Log |
| ple | Fungi | (h) | Level | Average* | Reduction |
| 4 | Aspergillus niger | 1.0 | 1.82 × 10e5 | 196,750 | −0.03 |
| 5 | Aspergillus niger | 24 | 1.82 × 10e5 | 5 | 4.56 |
| 6 | Aspergillus niger | 48 | 1.82 × 10e5 | 0, no | 5.26 |
| | | | | growth | |

*calculated from 3 plate counts

TABLE 5
Effectiveness of Composition 2 (pH = 3.54) and Composition 3
(pH = 9.50) against fungi spore Aspergillus niger.

| Exam- | | Time | Log Reduction | Log Reduction |
|---|---|---|---|---|
| ple | Fungi | (h) | (Composition 2) | (Composition 3) |
| 7 | Aspergillus niger | 0.5 | 4.25 | 3.95 |
| 8 | Aspergillus niger | 24 | 5.86 | 5.86 |

TABLE 6
Effectiveness of Composition 4 (pH =
8.75) against Selected Tomato Pathogens.

| Exam- | | Time | Inoculum | Log |
|---|---|---|---|---|
| ples | Bacteria | (sec) | Level | Reduction |
| 9 | E. coli 0157H7 | 15 | 4.04 × 10e5 | 5.61 |
| 10 | Erwinia carotovorum | 15 | 8.59 × 10e5 | 5.93 |
| | pectobacteri | | | |
| 11 | Erwinea amylavora | 15 | 7.58 × 10e5 | 5.88 |
| 12 | Salmonella choleraesuis | 15 | 4.55 × 10e5 | 5.66 |
| 13 | Listeria monocytogenes | 15 | 1.21 × 10e6 | 6.08 |

TABLE 7
Effectiveness of Composition 4 (pH =
8.75) against Selected Fungi.

| Exam- | | Time | Inoculum | Log |
|---|---|---|---|---|
| ple | Fungi | (h) | Level | Reduction |
| 14 | Alternaria Alternate | 0.5 | 3.46 × 10e5 | 3.72 |
| 15 | Alternaria Alternate | 24 | 3.46 × 10e5 | 5.54 |
| 16 | Alternaria Solani | 0.5 | 1.79 × 10e5 | 1.76 |
| 17 | Alternaria Solani | 24 | 1.79 × 10e5 | 5.25 |
| 18 | Botrytis cinerea | 0.5 | 5.08 × 10e5 | 3.52 |
| 19 | Botrytis cinerea | 24 | 5.08 × 10e5 | 5.71 |
| 20 | Fusarium oxysporum | 0.5 | 4.02 × 10e5 | 3.13 |
| 21 | Fusarium oxysporum | 24 | 4.02 × 10e5 | 5.60 |
| 22 | Fusarium solani | 0.5 | 1.27 × 10e5 | 3.81 |
| 23 | Fusarium solani | 24 | 1.27 × 10e5 | 6.10 |
| 24 | Phytophthora infestans | 0.5 | 1.62 × 10e5 | 3.81 |
| 25 | Phytophthora infestans | 24 | 1.62 × 10e5 | 5.21 |
| 26 | Phytophthora capscici | 0.5 | 1.62 × 10e5 | 4.10 |
| 27 | Phytophthora capscici | 24 | 1.62 × 10e5 | 5.71 |
| 28 | Phytophthora sojae | 0.5 | 5.71 × 10e5 | 3.24 |
| 29 | Phytophthora sojae | 24 | 5.71 × 10e5 | 5.76 |
| 30 | Colletotrichum | 0.5 | 6.04 × 10e5 | 4.05 |
| | gloeosporioides | | | |
| 31 | Colletotrichum | 24 | 6.04 × 10e5 | 5.78 |
| | gloeosporioides | | | |
| 32 | Colletotrichum capsici | 0.5 | 3.64 × 10e5 | 4.56 |
| 33 | Colletotrichum capsici | 24 | 3.64 × 10e5 | 5.56 |
| 34 | Colletotrichum coccodes | 0.5 | 1.74 × 10e5 | 3.95 |
| 35 | Colletotrichum coccodes | 24 | 1.74 × 10e5 | 6.24 |
| 36 | Corynespora cassiicola | 0.5 | 4.12 × 10e5 | 3.69 |
| 37 | Corynespora cassiicola | 24 | 4.12 × 10e5 | 5.61 |

1. An antimicrobial composition for treatment of produce to reduce the level of fungi and bacteria thereon comprising:
a source of chlorite ions; and
at least one enzyme;
the amount of the source of chlorite ions and of the enzyme being sufficient to reduce the level of fungi and bacteria.

2. The composition of claim 1, wherein the source of chlorite ions comprises sodium chlorite.

3. The composition of claim 1 where the enzyme is selected from the group consisting of protease, amylase, lipase, cellulase, and combinations thereof.

4. The composition of claim 1 further comprising a pH adjusting agent present in an effective amount to establish the composition at a pH in a range of about 3.1 to about 4.5.

5. The composition of claim 4 where the pH adjusting agent comprises citric acid.

6. The composition of claim 4, wherein the source of chlorite ions comprises of sodium chlorite.

7. The composition of claim 4 where the enzyme is selected from the group consisting of protease, amylase, lipase, cellulase, and combinations thereof.

8. An antimicrobial composition for treatment of produce to reduce the level of the amount of the source of chlorite ions, the enzyme and grapefruit seed extract being sufficient to reduce the level of fungi and bacteria.

9. The composition of claim 8, wherein the source of chlorite ions comprises sodium chlorite.

10. The composition of claim 8 where the enzyme is selected from the group consisting of protease, amylase, lipase, cellulase, and combinations thereof.

11. The composition of claim 8 further comprising a pH adjusting agent present in an effective amount to establish the composition at a pH in a range of about 3.1 to about 4.5.

12. The composition of claim 11 where the pH adjusting agent comprises citric acid.

13. The composition of claim 11, wherein the source of chlorite ions comprises of sodium chlorite.

14. The composition of claim 11 where the enzyme is selected from the group consisting of protease, amylase, lipase, cellulase, and combinations thereof.

15. A method of preserving produce from the action of bacteria or fungi comprising treating the produce to be protected, a plant, bearing said produce, or packing material for said produce picking material with an amount of any composition of claims 1-14 effective to reduce the level of bacteria and fungi.

16. A method of preserving produce from the action of bacteria or fungi comprising treating the produce to be protected, a plant, bearing said produce, or packing material for said produce picking material with an amount of any composition of claim 1 effective to reduce the level of bacteria and fungi.

17. A method of preserving produce from the action of bacteria or fungi comprising treating the produce to be protected, a plant, bearing said produce, or packing material for said produce picking material with an amount of any composition of claim 2 effective to reduce the level of bacteria and fungi.

18. A method of preserving produce from the action of bacteria or fungi comprising treating the produce to be protected, a plant, bearing said produce, or packing material for said produce picking material with an amount of any composition of claim 3 effective to reduce the level of bacteria and fungi.

19. A method of preserving produce from the action of bacteria or fungi comprising treating the produce to be protected, a plant, bearing said produce, or packing material for said produce picking material with an amount of any composition of claim 4 effective to reduce the level of bacteria and fungi.

20. A method of preserving produce from the action of bacteria or fungi comprising treating the produce to be protected, a plant, bearing said produce, or packing material for said produce picking material with an amount of any composition of claim 5 effective to reduce the level of bacteria and fungi.

21. A method of preserving produce from the action of bacteria or fungi comprising treating the produce to be protected, a plant, bearing said produce, or packing material for said produce picking material with an amount of any composition of claim 6 effective to reduce the level of bacteria and fungi.
